(19) United States
(12) Patent Application Publication
(10) Pub. No.: US 2025/0126010 A1
(43) Pub. Date: Apr. 17, 2025

(54) ACCESS POINT STATION, NON-ACCESS POINT STATION, AND WIRELESS COMMUNICATION METHOD

(71) Applicant: GUANGDONG OPPO MOBILE TELECOMMUNICATIONS CORP., LTD., Dongguan (CN)

(72) Inventor: Lei HUANG, Singapore (SG)

(21) Appl. No.: 18/999,041

(22) Filed: Dec. 23, 2024

Related U.S. Application Data
(63) Continuation of application No. PCT/CN2022/101631, filed on Jun. 27, 2022.

(51) Int. Cl. H04L 27/34; H04L 1/00

(52) U.S. Cl. CPC H04L 27/34; H04L 1/0003

(57) ABSTRACT

A wireless communication method includes: transmitting, by the AP-STA, an ultra-high reliability (UHR) physical protocol data unit (PPDU), where the UHR PPDU includes one or more physical service data units (PSDUs), the one or more PSDUs are processed according to a user-specific allocation information, the user-specific allocation information includes one or more UHR-modulation and coding schemes (UHR-MCSs) selected from a UHR-MCS set, and the UHR-MCS set includes inherited UHR-MCSs and/or non-inherited UHR-MCSs.

### CROSS-REFERENCE TO RELATED APPLICATIONS

This application is a Continuation Application of International Application No. PCT/CN2022/101631 filed Jun. 27, 2022, which is incorporated herein by reference in its entirety.

### TECHNICAL FIELD

The present disclosure relates to the field of communication systems, and more particularly, to an access point (AP) station (STA), a non-AP STA, and a wireless communication method, which can provide a good communication performance and/or provide high reliability.

### BACKGROUND

Communication systems such as wireless communication systems are widely deployed to provide various types of communication content such as voice, video, packet data, messaging, broadcast, and so on. These communication systems may be multiple-access systems capable of supporting communication with multiple users by sharing available system resources (such as, time, frequency, and power). A wireless network, for example a wireless local area network (WLAN), such as a Wi-Fi (i.e. institute of electrical and electronics engineer (IEEE) 802.11) network may include an access point (AP) station (STA) that may communicate with one or more non-AP STAs or mobile devices. It can be understood that as an example in the Wi-Fi field, this solution is not limited to use in this protocol such as IEEE 802.11. The WLAN enables a user to wirelessly access an internet based on radio frequency technology in a home, an office, or a specific service area using a portable terminal such as a personal digital assistant (PDA), a laptop computer, a portable multimedia player (PMP), a smartphone, etc. The AP STA may be coupled to a network, such as the internet, and may enable a mobile device to communicate via the network (or communicate with other devices coupled to the AP STA). A wireless device may communicate with a network device bi-directionally. For example, in a WLAN, a non-AP STA may communicate with an associated AP STA via downlink and uplink. The downlink may refer to a communication link from the AP STA to the non-AP STA, and the uplink may refer to a communication link from the non-AP STA to the AP STA or the non-AP STA to the non-AP STA.

IEEE 802.11 TGbe is developing a new IEEE 802.11 amendment which defines extremely high throughput (EHT) physical layer (PHY) and medium access control (MAC) layers capable of supporting a maximum throughput of at least 30 Gbps. IEEE 802.11 working group is also exploring a next generation Wi-Fi technology beyond IEEE 802.11be, which may target at a maximum throughput of at least 100 Gbps. The next generation Wi-Fi technology may be called eighth generation (GEN8), ultra-high reliability (UHR), or any other name. To this end, it may be necessary to develop an efficient link adaptation scheme for the next generation Wi-Fi technology. However, it is still an open issue what kind of modulation and coding schemes (MCSs) are supported for the next generation Wi-Fi technology to facilitate efficient link adaptation.

Therefore, there is a need for an access point (AP) station (STA), a non-AP STA, and a wireless communication method, which can solve issues in the prior art, improve system throughput, improve beam forming training, improve beam tracking, improve frequency diversity gain, reduce power consumption, achieve ultra-high throughput, provide good communication performance, and/or provide high reliability.

### SUMMARY

In a first aspect of the present disclosure, a wireless communication method by an AP STA includes transmitting, by the AP STA, an ultra-high reliability (UHR) physical protocol data unit (PPDU), where the UHR PPDU includes one or more physical service data units (PSDUs), the one or more PSDUs are processed according to a user-specific allocation information, the user-specific allocation information includes one or more UHR-modulation and coding schemes (UHR-MCSs) selected from a UHR-MCS set, and the UHR-MCS set includes inherited UHR-MCSs and/or non-inherited UHR-MCSs.

In a second aspect of the present disclosure, a wireless communication method by a non-AP STA includes transmitting an ultra-high reliability (UHR) physical protocol data unit (PPDU), where the UHR PPDU includes one or more physical service data units (PSDUs), the one or more PSDUs are processed according to a user-specific allocation information, the user-specific allocation information includes one or more UHR-modulation and coding schemes (UHR-MCSs) selected from a UHR-MCS set, and the UHR-MCS set includes inherited UHR-MCSs and/or non-inherited UHR-MCSs.

In a third aspect of the present disclosure, an AP STA includes a transmitter configured to transmit an ultra-high reliability (UHR) physical protocol data unit (PPDU), where the UHR PPDU includes one or more physical service data units (PSDUs), the one or more PSDUs are processed according to a user-specific allocation information, the user-specific allocation information includes one or more UHR-modulation and coding schemes (UHR-MCSs) selected from a UHR-MCS set, and the UHR-MCS set includes inherited UHR-MCSs and/or non-inherited UHR-MCSs.

In a fourth aspect of the present disclosure, a non-AP STA includes a transmitter configured to transmit an ultra-high reliability (UHR) physical protocol data unit (PPDU), where the UHR PPDU includes one or more physical service data units (PSDUs), the one or more PSDUs are processed according to a user-specific allocation information, the user-specific allocation information includes one or more UHR-modulation and coding schemes (UHR-MCSs) selected from a UHR-MCS set, and the UHR-MCS set includes inherited UHR-MCSs and/or non-inherited UHR-MCSs.

In a fifth aspect of the present disclosure, an AP STA includes a memory, a transceiver, and a processor coupled to the memory and the transceiver. The AP STA is configured to perform the above method.

In a sixth aspect of the present disclosure, a non-AP STA includes a memory, a transceiver, and a processor coupled to the memory and the transceiver. The non-AP STA is configured to perform the above method.

In a seventh aspect of the present disclosure, a non-transitory machine-readable storage medium has stored thereon instructions that, when executed by a computer, cause the computer to perform the above method.

In an eighth aspect of the present disclosure, a chip includes a processor, configured to call and run a computer program stored in a memory, to cause a device in which the chip is installed to execute the above method.

In a ninth aspect of the present disclosure, a non-transitory computer readable storage medium, in which a computer program is stored, causes a computer to execute the above method.

In a tenth aspect of the present disclosure, a computer program product includes a computer program, and the computer program causes a computer to execute the above method.

In an eleventh aspect of the present disclosure, a computer program causes a computer to execute the above method.

### BRIEF DESCRIPTION OF DRAWINGS

In order to illustrate the embodiments of the present disclosure more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1A is a schematic diagram illustrating an example of a UHR multi-user (MU) physical layer protocol data unit (PPDU) format according to an embodiment of the present disclosure.

FIG. 1B is a schematic diagram illustrating an example of a UHR trigger-based (TB) PPDU format according to an embodiment of the present disclosure.

FIG. 2 is a schematic diagram illustrating an example of a wireless communications system according to an embodiment of the present disclosure.

FIG. 3 is a schematic diagram illustrating an example of a wireless communications system according to another embodiment of the present disclosure.

FIG. 4 is a block diagram of one or more access point (AP) stations (STAs) and one or more non-AP STAs of communication in a wireless communications system according to an embodiment of the present disclosure.

FIG. 5 is a flowchart illustrating a wireless communication method performed by an AP STA according to an embodiment of the present disclosure.

FIG. 6 is a flowchart illustrating a wireless communication method performed by a non-AP STA according to another embodiment of the present disclosure.

FIG. 7 is a block diagram of an AP STA according to an embodiment of the present disclosure.

FIG. 8 is a block diagram of a non-AP STA according to an embodiment of the present disclosure.

FIG. 9 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

The following table shows abbreviations of terminologies and corresponding full names.

| Abbreviation | Full name |
|---|---|
| IEEE | institute of electrical and electronics engineers |
| WLAN | wireless local area network |
| BSS | basic service set |
| AP | access point |
| STA | station |
| PHY | physical layer |
| MAC | medium access control |
| PPDU | physical protocol data unit |
| HT | high throughput |
| EHT | extremely high throughput |
| UHR | ultra-high reliability |
| GEN8 | eighth generation |
| PER | Packet error rate |
| BW | bandwidth |
| GI | guard interval |
| BPSK | binary phase shift keying |
| QPSK | quadrature phase shift keying |
| QAM | quadrature amplitude modulation |
| SU | single user |
| DL | downlink |
| UL | uplink |
| MU | multi-user |
| MCS | modulation and coding scheme |
| LPI | low power indoor |
| DUP | duplicate |
| PSDU | physical service data unit |

Modulation schemes supported by IEEE 802.11be include BPSK, QPSK, 16 QAM, 64 QAM, 256 QAM, 1024 QAM, and 4096 QAM. An EHT-MCS set includes 16 EHT-MCSs. EHT-MCSs 0-13 and 15 are defined for a user in SU transmission or MU transmission; and EHT-MCS 14 is specifically defined for EHT DUP transmission in 6 GHz LPI channels. EHT-MCSs 14 and 15 are supported only with a single spatial stream. Parameters of EHT-MCSs are provided in Table 1.

It can be understood that all the tables in this solution can be regarded as a whole, or a part of the tables can form a solution. Tables can be combined with each other, the tables do not mean that all tables are required, the table(s) can partially cover the solution. Many variations and combinations of all the tables in this solution are possible within the framework of the present disclosure. Combinations of one or more aspects of all the tables or combinations of different tables are possible within the framework of the present disclosure.

TABLE 1

| EHT-MCS Index | Code rate | Modulation | Spectral efficiency |
|---|---|---|---|
| 0 | 0.5 | BPSK | 0.5 |
| 1 | 0.5 | QPSK | 1 |
| 2 | ¾ | QPSK | 1.5 |
| 3 | 0.5 | 16 QAM | 2 |
| 4 | ¾ | 16 QAM | 3 |
| 5 | ⅔ | 64 QAM | 4 |
| 6 | ¾ | 64 QAM | 4.5 |
| 7 | ⅚ | 64 QAM | 5 |
| 8 | ¾ | 256 QAM | 6 |
| 9 | ⅚ | 256 QAM | 6.67 |
| 10 | ¾ | 1024 QAM | 7.5 |
| 11 | ⅚ | 1024 QAM | 8.33 |
| 12 | ¾ | 4096 QAM | 9 |
| 13 | ⅚ | 4096 QAM | 10 |
| 14 | EHT DUP | | |
| 15 | 0.5 | BPSK-DCM | 0.25 |

A UHR PPDU has a bandwidth of 20 MHz, 40 MHz, 80 MHz, 160 MHz, 320 MHz, or 640 MHz. 80 MHz or 160 MHz are only applicable to 5 GHz band and 6 GHz band; and 320 MHz or 640 MHz BW UHR PPDU is only applicable to 6 GHz band. The tone plan and RU locations for a 20 MHz UHR PPDU, 40 MHZ UHR PPDU, 80 MHZ UHR PPDU, 160 MHZ UHR PPDU, or 320 MHz UHR PPDU are identical to those of EHT PHY. A 640 MHz UHR PPDU is composed of eight 80 MHz subblocks, for each of which the tone plan and RU allocations are identical to those of an 80 MHz EHT PPDU.

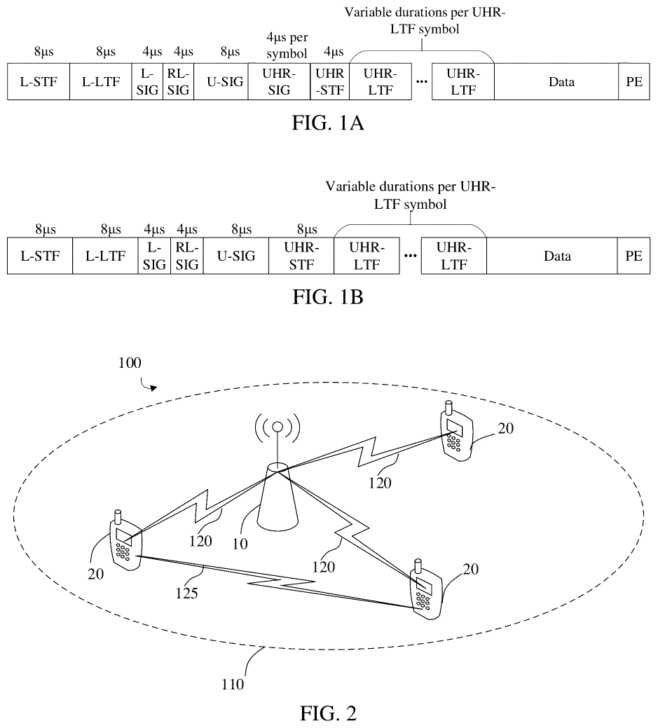

UHR PPDU has two formats: UHR MU PPDU and UHR TB PPDU. The UHR MU PPDU format as illustrated in FIG. 1A is used for transmission to one or more users if the PPDU is not a response of a Trigger frame. A UHR MU PPDU can be transmitted by an AP STA or a non-AP STA. In a UHR MU PPDU, L-STF, L-LTF, L-SIG, RL-SIG, U-SIG, and UHR-SIG fields are called pre-UHR modulated fields while UHR-STF, UHR-LTF, data, and PE fields are called UHR modulated fields. The UHR TB PPDU format as illustrated in FIG. 1B is used for a non-AP STA's transmission that is a response to a Trigger frame from an AP STA. In a UHR TB PPDU, L-STF, L-LTF, L-SIG, RL-SIG and U-SIG fields are called pre-UHR modulated fields while UHR-STF, UHR-LTF, data, and PE fields are called UHR modulated fields. The duration of the UHR-STF field in the UHR TB PPDU is twice the duration of the UHR-STF field in the UHR MU PPDU. For a UHR PPDU, each UHR-LTF symbol has the same GI duration as each data symbol, which is 0.8 μs, 1.6 μs, or 3.2 μs. The UHR-LTF field includes three types: 1× UHR-LTF, 2× UHR-LTF, and 4× UHR-LTF. The duration of each 1× UHR-LTF, 2× UHR-LTF, or 4× UHR-LTF symbol without GI is 3.2 μs, 6.4 μs or 12.8 μs. Each data symbol without GI is 12.8 μs.

The data field of a UHR MU PPDU carries a PSDU for each of one or more intended STAs and the UHR-SIG field of the UHR MU PPDU includes a user field for each intended STA, which carries user-specific allocation information for the STA, including MCS, number of spatial stream and coding scheme, etc. The PSDU of each intended STA is processed according to its user-specific allocation information.

The data field of a UHR TB PPDU transmitted by a non-AP STA carries a single PSDU and a trigger frame soliciting the UHR TB PPDU includes a user info field for the non-AP STA, which carries user-specific allocation information for the non-AP STA, including MCS, number of spatial stream and coding scheme, etc. The PSDU is processed according to the user-specific allocation information for the non-AP STA.

In addition to BPSK, QPSK, 16 QAM, 64 QAM, 256 QAM, 1024 QAM, and 4096 QAM, the UHR PHY supports 16384 QAM, which may further increase link throughput. It can be understood that the modulation order supported by the UHR PHY may be even larger than 16384 (e.g. 65536). The number of UHR-MCSs in a UHR-MCS set may be larger than the number of EHT-MCSs in an EHT-MCS set, and the UHR PHY provides MCSs with finer granularity than EHT PHY in terms of spectral efficiency, which may facilitate more efficient link adaptation. Alternatively, the number of UHR-MCSs in a UHR-MCS set may be equal to the number of EHT-MCSs in an EHT-MCS set, and the UHR PHY provides different MCSs with same spectral efficiency to EHT PHY, which may enable better PER performance.

One or more UHR-MCSs in a UHR-MCS set are classified into one or more inherited UHR-MCSs and one or more non-inherited UHR-MCSs. The one or more inherited UHR-MCSs have their respective EHT-MCS counterparts; while the one or more non-inherited UHR-MCSs do not have their respective EHT-MCS counterparts. The inherited UHR-MCSs refer to MCSs that are supported in EHT PHY or other earlier protocols/Wi-Fi technologies, such as: BPSK-DCM with code rate of ½, BPSK with code rate of ½, QPSK with code rate of ½ or ¾, 16 QAM with code rate of ½ or ¾, 64 QAM with code rate of ⅔, ¾ or ⅚, 256 QAM with code rate of ¾, 1024 QAM with code rate of ¾ or ⅚, and 4096 QAM with code rate of ¾ or ⅚. The non-inherited UHR-MCSs refer to MCSs that are not supported in EHT PHY or other earlier protocols/Wi-Fi technologies (such as 16384 QAM).

Many variations and combinations of embodiments (for example, embodiment 1 and its optional examples 1 and 2, embodiment 2 and its optional examples 1 and 2, embodiment 3, and embodiment 4, but not limited to) are possible within the framework of the present disclosure. Combinations of one or more aspects of the embodiments or combinations of different embodiments are possible within the framework of the present disclosure.

Embodiment 1 as an embodiment.

The UHR-MCS set includes 16 inherited UHR-MCSs described below.

A UHR-MCS with BPSK-DCM and code rate of ½, a UHR-MCS with BPSK and code rate of ½, a UHR-MCS with QPSK and code rate of ½, a UHR-MCS with QPSK and code rate of ¾, a UHR-MCS with 16 QAM and code rate of ½, a UHR-MCS with 16 QAM and code rate of ¾, a UHR-MCS with 64 QAM and code rate of ⅔, a UHR-MCS with 64 QAM and code rate of ¾, and a UHR-MCS with 64 QAM and code rate of ⅚.

A UHR-MCS with 256 QAM and code rate of ¾, and a UHR-MCS with 256 QAM and code rate of ⅚.

A UHR-MCS with 1024 QAM and code rate of ¾ and a UHR-MCS with 1024 QAM and code rate of ⅚, and a UHR-MCS with 4096 QAM and code rate of ¾ and a UHR-MCS with 4096 QAM and code rate of ⅚.

A UHR-MCS specifically for UHR DUP transmission in 6 GHz band.

Optional example 1 as another embodiment:

The UHR-MCS set includes 9 non-inherited UHR-MCSs described below:

A UHR-MCS with QPSK and code rate of ⅔, a UHR-MCS with QPSK and code rate of ⅚, a UHR-MCS with 16 QAM and code rate of ⅔, a UHR-MCS with 16 QAM and code rate of ⅚, and a UHR-MCS with 256 QAM and code rate of ⅔.

A UHR-MCS with 4096 QAM and code rate of ⅔.

A UHR-MCS with 16384 QAM and code rate of ⅔.

A UHR-MCS with 16384 QAM and code rate of ¾; and a UHR-MCS with 16384 QAM and code rate of ⅚.

Optional example 2 as another embodiment

The UHR-MCS set includes 8 non-inherited UHR-MCSs, which are the same as the optional example 1 excluding a UHR-MCS with 16384 QAM and code rate of ⅔. Considering the UHR-MCS with 16384 QAM and code rate of ⅔ has a lower spectral efficiency than the UHR-MCS with 4096 QAM with code rate of ⅚, the UHR-MCS set may not be necessary to include the UHR-MCS with 16384 QAM and code rate of ⅔.

The UHR-MCS with BPSK-DCM and code rate of ½ and the UHR-MCS specifically for UHR DUP transmission in 6 GHz band are supported only with a single spatial stream. Except for the UHR-MCS specifically for UHR DUP transmission in 6 GHz band, the other UHR-MCSs are defined for a user in SU or MU transmission.

Embodiment 2 as an embodiment

The UHR-MCS set includes 15 inherited UHR-MCSs described below.

A UHR-MCS with BPSK-DCM and code rate of ½, a UHR-MCS with BPSK and code rate of ½, a UHR-MCS with QPSK and code rate of ½, a UHR-MCS with QPSK and code rate of ¾, a UHR-MCS with 16 QAM and code rate of ½, a UHR-MCS with 16 QAM and code rate of ¾, a UHR-MCS with 64 QAM and code rate of ⅔, a UHR-MCS with 64 QAM and code rate of ¾, and a UHR-MCS with 64 QAM and code rate of ⅚.

A UHR-MCS with 256 QAM and code rate of ¾.

A UHR-MCS with 1024 QAM and code rate of ¾ and a UHR-MCS with 1024 QAM and code rate of ⅚, and a UHR-MCS with 4096 QAM and code rate of ¾ and a UHR-MCS with 4096 QAM and code rate of ⅚.

A UHR-MCS specifically for UHR DUP transmission in 6 GHz band.

Optional example 1 as another embodiment

The UHR-MCS set includes 10 non-inherited UHR-MCSs described below.

A UHR-MCS with QPSK and code rate of ⅔, a UHR-MCS with QPSK and code rate of ⅚, a UHR-MCS with 16 QAM and code rate of ⅔, a UHR-MCS with 16 QAM and code rate of ⅚, and a UHR-MCS with 256 QAM and code rate of ⅔.

A UHR-MCS with 1024 QAM and code rate of ⅔.

A UHR-MCS with 4096 QAM and code rate of ⅔.

A UHR-MCS with 16384 QAM and code rate of ⅔.

A UHR-MCS with 16384 QAM and code rate of ¾; and a UHR-MCS with 16384 QAM and code rate of ⅚.

Optional example 2 as an embodiment

The UHR-MCS includes 9 non-inherited UHR-MCSs, which are the same as the optional example 1 excluding a UHR-MCS with 16384 QAM and code rate of ⅔.

The UHR-MCS with 1024 QAM and code rate of ⅔ used in the second embodiment and the UHR-MCS with 256 QAM and code rate of ⅚ used in the first embodiment have a same spectral efficiency. Considering throughput and PER performance gain may be higher using higher modulation order and lower code rate combinations due to the fact that lower code rate is more resistant to channel fading, the UHR-MCS with 1024 QAM and code rate of ⅔ used in the second embodiment may be favorable than the UHR-MCS with 256 QAM and code rate of ⅚ used in the first embodiment.

The UHR-MCS with BPSK-DCM and code rate of ½ and the UHR-MCS specifically for UHR DUP transmission in 6 GHz band are supported only with a single spatial stream. Except for the UHR-MCS specifically for UHR DUP transmission in 6 GHz band, the other UHR-MCSs are defined for a user in SU or MU transmission. 16384 QAM

In 16384 QAM, each constellation point is characterized by an I coordinate and a Q coordinate on an odd-integer grid between −127 and 127 and encodes 14 bits. The final constellation point is given by:

$$d = ( 1 + j Q ) \times {K}_{M O D}$$

The first 7 bits determine the I value of the constellation point, while the subsequent 7 bits determine the Q value of the constellation point, and j is an imaginary part of a complex number. Encoding of both I and Q is illustrated in Table 2, which follows Gray-coding to minimize the number of bit errors per symbol. To normalize the constellation to unit energy, the constellation points need to be scaled with a factor K_{MOD}=1/sqrt (10922).

It can be understood that all the tables in this solution can be regarded as a whole, or a part of the tables can form a solution. Many variations and combinations of all the tables in this solution are possible within the framework of the present disclosure. Combinations of one or more aspects of all the tables or combinations of different tables are possible within the framework of the present disclosure.

TABLE 2

| | Input bits (I: B0 B1 B2 B3 B4 B5 B6 or | | | | | | |
|---|---|---|---|---|---|---|---|
| Coordinate | Q: B7 B8 B9 B10 B11 B12 B13) | | | | | | |
| −127 | 0 | 0 | 0 | 0 | 0 | 0 | 0 |
| −125 | 0 | 0 | 0 | 0 | 0 | 0 | 1 |
| −123 | 0 | 0 | 0 | 0 | 0 | 1 | 0 |
| −121 | 0 | 0 | 0 | 0 | 0 | 1 | 1 |
| −119 | 0 | 0 | 0 | 0 | 1 | 0 | 0 |
| −117 | 0 | 0 | 0 | 0 | 1 | 0 | 1 |
| −115 | 0 | 0 | 0 | 0 | 1 | 1 | 0 |
| −113 | 0 | 0 | 0 | 0 | 1 | 1 | 1 |
| −111 | 0 | 0 | 0 | 1 | 0 | 0 | 0 |
| −109 | 0 | 0 | 0 | 1 | 0 | 0 | 1 |
| −107 | 0 | 0 | 0 | 1 | 0 | 1 | 0 |
| −105 | 0 | 0 | 0 | 1 | 0 | 1 | 1 |
| −103 | 0 | 0 | 0 | 1 | 1 | 0 | 0 |
| −101 | 0 | 0 | 0 | 1 | 1 | 0 | 1 |
| −99 | 0 | 0 | 0 | 1 | 1 | 1 | 0 |
| −97 | 0 | 0 | 0 | 1 | 1 | 1 | 1 |
| −95 | 0 | 0 | 1 | 0 | 0 | 0 | 0 |
| −93 | 0 | 0 | 1 | 0 | 0 | 0 | 1 |
| −91 | 0 | 0 | 1 | 0 | 0 | 1 | 0 |
| −89 | 0 | 0 | 1 | 0 | 0 | 1 | 1 |
| −87 | 0 | 0 | 1 | 0 | 1 | 0 | 0 |
| −85 | 0 | 0 | 1 | 0 | 1 | 0 | 1 |
| −83 | 0 | 0 | 1 | 0 | 1 | 1 | 0 |
| −81 | 0 | 0 | 1 | 0 | 1 | 1 | 1 |
| −79 | 0 | 0 | 1 | 1 | 0 | 0 | 0 |
| −77 | 0 | 0 | 1 | 1 | 0 | 0 | 1 |
| −75 | 0 | 0 | 1 | 1 | 0 | 1 | 0 |
| −73 | 0 | 0 | 1 | 1 | 0 | 1 | 1 |
| −71 | 0 | 0 | 1 | 1 | 1 | 0 | 0 |
| −69 | 0 | 0 | 1 | 1 | 1 | 0 | 1 |
| −67 | 0 | 0 | 1 | 1 | 1 | 1 | 0 |
| −65 | 0 | 0 | 1 | 1 | 1 | 1 | 1 |
| −63 | 0 | 1 | 0 | 0 | 0 | 0 | 0 |
| −61 | 0 | 1 | 0 | 0 | 0 | 0 | 1 |
| −59 | 0 | 1 | 0 | 0 | 0 | 1 | 0 |
| −57 | 0 | 1 | 0 | 0 | 0 | 1 | 1 |
| −55 | 0 | 1 | 0 | 0 | 1 | 0 | 0 |
| −53 | 0 | 1 | 0 | 0 | 1 | 0 | 1 |
| −51 | 0 | 1 | 0 | 0 | 1 | 1 | 0 |
| −49 | 0 | 1 | 0 | 0 | 1 | 1 | 1 |
| −47 | 0 | 1 | 0 | 1 | 0 | 0 | 0 |
| −45 | 0 | 1 | 0 | 1 | 0 | 0 | 1 |
| −43 | 0 | 1 | 0 | 1 | 0 | 1 | 0 |
| −41 | 0 | 1 | 0 | 1 | 0 | 1 | 1 |
| −39 | 0 | 1 | 0 | 1 | 1 | 0 | 0 |
| −37 | 0 | 1 | 0 | 1 | 1 | 0 | 1 |
| −35 | 0 | 1 | 0 | 1 | 1 | 1 | 0 |
| −33 | 0 | 1 | 0 | 1 | 1 | 1 | 1 |
| −31 | 0 | 1 | 1 | 0 | 0 | 0 | 0 |
| −29 | 0 | 1 | 1 | 0 | 0 | 0 | 1 |
| −27 | 0 | 1 | 1 | 0 | 0 | 1 | 0 |
| −25 | 0 | 1 | 1 | 0 | 0 | 1 | 1 |
| −23 | 0 | 1 | 1 | 0 | 1 | 0 | 0 |
| −21 | 0 | 1 | 1 | 0 | 1 | 0 | 1 |
| −19 | 0 | 1 | 1 | 0 | 1 | 1 | 0 |
| −17 | 0 | 1 | 1 | 0 | 1 | 1 | 1 |
| −15 | 0 | 1 | 1 | 1 | 0 | 0 | 0 |
| −13 | 0 | 1 | 1 | 1 | 0 | 0 | 1 |
| −11 | 0 | 1 | 1 | 1 | 0 | 1 | 0 |
| −9 | 0 | 1 | 1 | 1 | 0 | 1 | 1 |
| −7 | 0 | 1 | 1 | 1 | 1 | 0 | 0 |
| −5 | 0 | 1 | 1 | 1 | 1 | 0 | 1 |
| −3 | 0 | 1 | 1 | 1 | 1 | 1 | 0 |
| −1 | 0 | 1 | 1 | 1 | 1 | 1 | 1 |
| 1 | 1 | 1 | 1 | 1 | 1 | 1 | 1 |
| 3 | 1 | 1 | 1 | 1 | 1 | 1 | 0 |
| 5 | 1 | 1 | 1 | 1 | 1 | 0 | 1 |
| 7 | 1 | 1 | 1 | 1 | 1 | 0 | 0 |
| 9 | 1 | 1 | 1 | 1 | 0 | 1 | 1 |
| 11 | 1 | 1 | 1 | 1 | 0 | 1 | 0 |
| 13 | 1 | 1 | 1 | 1 | 0 | 0 | 1 |
| 15 | 1 | 1 | 1 | 1 | 0 | 0 | 0 |
| 17 | 1 | 1 | 1 | 0 | 1 | 1 | 1 |
| 19 | 1 | 1 | 1 | 0 | 1 | 1 | 0 |
| 21 | 1 | 1 | 1 | 0 | 1 | 0 | 1 |
| 23 | 1 | 1 | 1 | 0 | 1 | 0 | 0 |
| 25 | 1 | 1 | 1 | 0 | 0 | 1 | 1 |
| 27 | 1 | 1 | 1 | 0 | 0 | 1 | 0 |
| 29 | 1 | 1 | 1 | 0 | 0 | 0 | 1 |
| 31 | 1 | 1 | 1 | 0 | 0 | 0 | 0 |
| 33 | 1 | 1 | 0 | 1 | 1 | 1 | 1 |
| 35 | 1 | 1 | 0 | 1 | 1 | 1 | 0 |
| 37 | 1 | 1 | 0 | 1 | 1 | 0 | 1 |
| 39 | 1 | 1 | 0 | 1 | 1 | 0 | 0 |
| 41 | 1 | 1 | 0 | 1 | 0 | 1 | 1 |
| 43 | 1 | 1 | 0 | 1 | 0 | 1 | 0 |
| 45 | 1 | 1 | 0 | 1 | 0 | 0 | 1 |
| 47 | 1 | 1 | 0 | 1 | 0 | 0 | 0 |
| 49 | 1 | 1 | 0 | 0 | 1 | 1 | 1 |
| 51 | 1 | 1 | 0 | 0 | 1 | 1 | 0 |
| 53 | 1 | 1 | 0 | 0 | 1 | 0 | 1 |
| 55 | 1 | 1 | 0 | 0 | 1 | 0 | 0 |
| 57 | 1 | 1 | 0 | 0 | 0 | 1 | 1 |
| 59 | 1 | 1 | 0 | 0 | 0 | 1 | 0 |
| 61 | 1 | 1 | 0 | 0 | 0 | 0 | 1 |
| 63 | 1 | 1 | 0 | 0 | 0 | 0 | 0 |
| 65 | 1 | 0 | 1 | 1 | 1 | 1 | 1 |
| 67 | 1 | 0 | 1 | 1 | 1 | 1 | 0 |
| 69 | 1 | 0 | 1 | 1 | 1 | 0 | 1 |
| 71 | 1 | 0 | 1 | 1 | 1 | 0 | 0 |
| 73 | 1 | 0 | 1 | 1 | 0 | 1 | 1 |
| 75 | 1 | 0 | 1 | 1 | 0 | 1 | 0 |
| 77 | 1 | 0 | 1 | 1 | 0 | 0 | 1 |
| 79 | 1 | 0 | 1 | 1 | 0 | 0 | 0 |
| 81 | 1 | 0 | 1 | 0 | 1 | 1 | 1 |
| 83 | 1 | 0 | 1 | 0 | 1 | 1 | 0 |
| 85 | 1 | 0 | 1 | 0 | 1 | 0 | 1 |
| 87 | 1 | 0 | 1 | 0 | 1 | 0 | 0 |
| 89 | 1 | 0 | 1 | 0 | 0 | 1 | 1 |
| 91 | 1 | 0 | 1 | 0 | 0 | 1 | 0 |
| 93 | 1 | 0 | 1 | 0 | 0 | 0 | 1 |
| 95 | 1 | 0 | 1 | 0 | 0 | 0 | 0 |
| 97 | 1 | 0 | 0 | 1 | 1 | 1 | 1 |
| 99 | 1 | 0 | 0 | 1 | 1 | 1 | 0 |
| 101 | 1 | 0 | 0 | 1 | 1 | 0 | 1 |
| 103 | 1 | 0 | 0 | 1 | 1 | 0 | 0 |
| 105 | 1 | 0 | 0 | 1 | 0 | 1 | 1 |
| 107 | 1 | 0 | 0 | 1 | 0 | 1 | 0 |
| 109 | 1 | 0 | 0 | 1 | 0 | 0 | 1 |
| 111 | 1 | 0 | 0 | 1 | 0 | 0 | 0 |
| 113 | 1 | 0 | 0 | 0 | 1 | 1 | 1 |
| 115 | 1 | 0 | 0 | 0 | 1 | 1 | 0 |
| 117 | 1 | 0 | 0 | 0 | 1 | 0 | 1 |
| 119 | 1 | 0 | 0 | 0 | 1 | 0 | 0 |
| 121 | 1 | 0 | 0 | 0 | 0 | 1 | 1 |
| 123 | 1 | 0 | 0 | 0 | 0 | 1 | 0 |
| 125 | 1 | 0 | 0 | 0 | 0 | 0 | 1 |
| 127 | 1 | 0 | 0 | 0 | 0 | 0 | 0 |

UHR-MCS indexing and signaling.

### Embodiment 3

The inherited UHR-MCSs and the non-inherited UHR-MCSs in the UHR-MCS set are jointly indexed.

### Example 1

For the UHR-MCS set defined in the optional example 1 of the first embodiment, parameters of UHR-MCSs are provided in Table 2A. For the UHR-MCS set defined in the optional example 2 of the first embodiment, UHR-MCS 22 in Table 2A can be removed.

TABLE 2A

| UHR-MCS Index | Code rate | Modulation | Spectral efficiency |
|---|---|---|---|
| 0 | UHR DUP | | |
| 1 | 0.5 | BPSK-DCM | 0.25 |
| 2 | 0.5 | BPSK | 0.5 |
| 3 | 0.5 | QPSK | 1 |
| 4 | ⅔ | QPSK | 1.33 |
| 5 | ¾ | QPSK | 1.5 |
| 6 | ⅚ | QPSK | 1.67 |
| 7 | 0.5 | 16 QAM | 2 |
| 8 | ⅔ | 16 QAM | 2.67 |
| 9 | ¾ | 16 QAM | 3 |
| 10 | ⅚ | 16 QAM | 3.33 |
| 11 | ⅔ | 64 QAM | 4 |
| 12 | ¾ | 64 QAM | 4.5 |
| 13 | ⅚ | 64 QAM | 5 |
| 14 | ⅔ | 256 QAM | 5.33 |
| 15 | ¾ | 256 QAM | 6 |
| 16 | ⅚ | 256 QAM | 6.67 |
| 17 | ¾ | 1024 QAM | 7.5 |
| 18 | ⅚ | 1024 QAM | 8.33 |
| 19 | ⅔ | 4096 QAM | 8 |
| 20 | ¾ | 4096 QAM | 9 |
| 21 | ⅚ | 4096 QAM | 10 |
| 22 | ⅔ | 16384 QAM | 9.33 |
| 23 | ¾ | 16384 QAM | 10.5 |
| 24 | ⅚ | 16384 QAM | 11.67 |

| | |
|---|---|
| 25-31 | Reserved |

For the UHR-MCS set defined in the optional example 1 of the second embodiment, parameters of UHR-MCSs are provided in Table 2B. For the UHR-MCS set defined in the optional example 2 of the second embodiment, UHR-MCS 22 in Table 2B can be removed.

TABLE 2B

| UHR-MCS Index | Code rate | Modulation | Spectral efficiency |
|---|---|---|---|
| 0 | UHR DUP | | |
| 1 | 0.5 | BPSK-DCM | 0.25 |
| 2 | 0.5 | BPSK | 0.5 |
| 3 | 0.5 | QPSK | 1 |
| 4 | ⅔ | QPSK | 1.33 |
| 5 | ¾ | QPSK | 1.5 |
| 6 | ⅚ | QPSK | 1.67 |
| 7 | 0.5 | 16 QAM | 2 |
| 8 | ⅔ | 16 QAM | 2.67 |
| 9 | ¾ | 16 QAM | 3 |
| 10 | ⅚ | 16 QAM | 3.33 |
| 11 | ⅔ | 64 QAM | 4 |
| 12 | ¾ | 64 QAM | 4.5 |
| 13 | ⅚ | 64 QAM | 5 |
| 14 | ⅔ | 256 QAM | 5.33 |
| 15 | ¾ | 256 QAM | 6 |
| 16 | ⅔ | 1024 QAM | 6.67 |
| 17 | ¾ | 1024 QAM | 7.5 |
| 18 | ⅚ | 1024 QAM | 8.33 |
| 19 | ⅔ | 4096 QAM | 8 |
| 20 | ¾ | 4096 QAM | 9 |
| 21 | ⅚ | 4096 QAM | 10 |
| 22 | ⅔ | 16384 QAM | 9.33 |
| 23 | ¾ | 16384 QAM | 10.5 |
| 24 | ⅚ | 16384 QAM | 11.67 |

| | |
|---|---|
| 25-31 | Reserved |

In the UHR-SIG field of a UHR MU PPDU, a user field for each intended user of the PSDUs carried in the data field of the UHR MU PPDU includes a 5-bit MCS field, which indicates an UHR-MCS index for the intended user. In the trigger frame soliciting a UHR TB PPDU from a non-AP STA, a user info field for the non-AP STA includes a 5-bit MCS field, which indicates a UHR-MCS index for the non-AP STA. Alternatively, a user info field for the non-AP STA includes a 4-bit MCS field and a 1-bit MCS extension field, which are combined to indicate a UHR-MCS index for the non-AP STA as illustrated in Table 3.

TABLE 3

| MCS extension field | MCS field | UHR-MCS Index |
|---|---|---|
| 0 | 0 | 0 |
| 0 | 1 | 1 |
| 0 | 2 | 2 |
| 0 | 3 | 3 |
| 0 | 4 | 4 |
| 0 | 5 | 5 |
| 0 | 6 | 6 |
| 0 | 7 | 7 |
| 0 | 8 | 8 |
| 0 | 9 | 9 |
| 0 | 10 | 10 |
| 0 | 11 | 11 |
| 0 | 12 | 12 |
| 0 | 13 | 13 |
| 0 | 14 | 14 |
| 0 | 15 | 15 |
| 1 | 0 | 16 |
| 1 | 1 | 17 |
| 1 | 2 | 18 |
| 1 | 3 | 19 |
| 1 | 4 | 20 |
| 1 | 5 | 21 |
| 1 | 6 | 22 |
| 1 | 7 | 23 |
| 1 | 8 | 24 |
| 1 | 9-15 | reserved |

### Example 2

For ease of implementation, the inherited UHR-MCSs are indexed before the non-inherited UHR-MCSs, and each inherited UHR-MCS has a same index as its EHT-MCS counterpart. For example, the index of the UHR-MCS with QPSK and code rate of ¾ is 2, which is the same as the index of the EHT-MCS with QPSK and code rate of ¾. For the UHR-MCS set defined in the optional example 1 of the first embodiment, parameters of UHR-MCSs are provided in Table 4A. For the UHR-MCS set defined in the optional example 2 of the first embodiment, UHR-MCS 22 in Table 4A can be removed.

TABLE 4A

| UHR-MCS Index | Code rate | Modulation | Spectral efficiency |
|---|---|---|---|
| 0 | 0.5 | BPSK | 0.5 |
| 1 | 0.5 | QPSK | 1 |
| 2 | ¾ | QPSK | 1.5 |
| 3 | 0.5 | 16 QAM | 2 |
| 4 | ¾ | 16 QAM | 3 |
| 5 | ⅔ | 64 QAM | 4 |
| 6 | ¾ | 64 QAM | 4.5 |
| 7 | ⅚ | 64 QAM | 5 |
| 8 | ¾ | 256 QAM | 6 |
| 9 | ⅚ | 256 QAM | 6.67 |
| 10 | ¾ | 1024 QAM | 7.5 |
| 11 | ⅚ | 1024 QAM | 8.33 |
| 12 | ¾ | 4096 QAM | 9 |
| 13 | ⅚ | 4096 QAM | 10 |
| 14 | UHR DUP | | |
| 15 | 0.5 | BPSK-DCM | 0.25 |
| 16 | ⅔ | QPSK | 1.33 |
| 17 | ⅚ | QPSK | 1.67 |
| 18 | ⅔ | 16 QAM | 2.67 |
| 19 | ⅚ | 16 QAM | 3.33 |
| 20 | ⅔ | 256 QAM | 5.33 |
| 21 | ⅔ | 4096 QAM | 8 |
| 22 | ⅔ | 16384 QAM | 9.33 |
| 23 | ¾ | 16384 QAM | 10.5 |
| 24 | ⅚ | 16384 QAM | 11.67 |

| | |
|---|---|
| 25-31 | Reserved |

For the UHR-MCS set defined in the optional example 1 of the second embodiment, parameters of UHR-MCSs are provided in Table 4B. For the UHR-MCS set defined in the optional example 2 of the second embodiment, UHR-MCS 23 in Table 4B can be removed.

TABLE 4B

| UHR-MCS Index | Code rate | Modulation | Spectral efficiency |
|---|---|---|---|
| 0 | 0.5 | BPSK | 0.5 |
| 1 | 0.5 | QPSK | 1 |
| 2 | ¾ | QPSK | 1.5 |
| 3 | 0.5 | 16 QAM | 2 |
| 4 | ¾ | 16 QAM | 3 |
| 5 | ⅔ | 64 QAM | 4 |
| 6 | ¾ | 64 QAM | 4.5 |
| 7 | ⅚ | 64 QAM | 5 |
| 8 | ¾ | 256 QAM | 6 |
| 9 | Reserved | | |
| 10 | ¾ | 1024 QAM | 7.5 |
| 11 | ⅚ | 1024 QAM | 8.33 |
| 12 | ¾ | 4096 QAM | 9 |
| 13 | ⅚ | 4096 QAM | 10 |
| 14 | UHR DUP | | |
| 15 | 0.5 | BPSK-DCM | 0.25 |
| 16 | ⅔ | QPSK | 1.33 |
| 17 | ⅚ | QPSK | 1.67 |
| 18 | ⅔ | 16 QAM | 2.67 |
| 19 | ⅚ | 16 QAM | 3.33 |
| 20 | ⅔ | 256 QAM | 5.33 |
| 21 | ⅔ | 1024 QAM | 6.67 |
| 22 | ⅔ | 4096 QAM | 8 |
| 23 | ⅔ | 16384 QAM | 9.33 |
| 24 | ¾ | 16384 QAM | 10.5 |
| 25 | ⅚ | 16384 QAM | 11.67 |

| | |
|---|---|
| 26-31 | Reserved |

In the UHR-SIG field of a UHR MU PPDU, a user field for each intended user of the PSDUs carried in the data field of the UHR MU PPDU includes a 5-bit MCS field, which indicates a UHR-MCS index for the intended user. In the trigger frame soliciting a UHR TB PPDU from a non-AP STA, a user info field for the non-AP STA includes a 5-bit MCS field, which indicates a UHR-MCS index for the non-AP STA. Alternatively, a user info field for the non-AP STA includes a 4-bit MCS field and a 1-bit MCS extension field, which are combined to indicate a UHR-MCS index for the non-AP STA as illustrated in Table 5.

TABLE 5

| MCS extension field | MCS field | UHR-MCS Index |
|---|---|---|
| 0 | 0 | 0 |
| 0 | 1 | 1 |
| 0 | 2 | 2 |
| 0 | 3 | 3 |
| 0 | 4 | 4 |
| 0 | 5 | 5 |
| 0 | 6 | 6 |
| 0 | 7 | 7 |
| 0 | 8 | 8 |
| 0 | 9 | Reserved |
| 0 | 10 | 10 |
| 0 | 11 | 11 |
| 0 | 12 | 12 |
| 0 | 13 | 13 |
| 0 | 14 | 14 |
| 0 | 15 | 15 |
| 1 | 0 | 16 |
| 1 | 1 | 17 |
| 1 | 2 | 18 |
| 1 | 3 | 19 |
| 1 | 4 | 20 |
| 1 | 5 | 21 |
| 1 | 6 | 22 |
| 1 | 7 | 23 |
| 1 | 8 | 24 |
| 1 | 9 | 25 |
| 1 | 10-15 | Reserved |

### Embodiment 4

The inherited UHR-MCSs and the non-inherited UHR-MCSs in the UHR-MCS set are separately indexed.

### Example 3

For the UHR-MCS set defined in the optional example 1 of the first embodiment, parameters of the inherited UHR-MCSs are provided in Table 6A and parameters of the non-inherited UHR-MCSs are provided in Table 6B. For the UHR-MCS set defined in the optional example 2 of the first embodiment, UHR-MCS 6 in Table 6B can be removed.

TABLE 6A

| UHR-MCS Index | Code rate | Modulation | Spectral efficiency |
|---|---|---|---|
| 0 | 0.5 | BPSK | 0.5 |
| 1 | 0.5 | QPSK | 1 |
| 2 | ¾ | QPSK | 1.5 |
| 3 | 0.5 | 16 QAM | 2 |
| 4 | ¾ | 16 QAM | 3 |
| 5 | ⅔ | 64 QAM | 4 |
| 6 | ¾ | 64 QAM | 4.5 |
| 7 | ⅚ | 64 QAM | 5 |
| 8 | ¾ | 256 QAM | 6 |
| 9 | ⅚ | 256 QAM | 6.67 |
| 10 | ¾ | 1024 QAM | 7.5 |
| 11 | ⅚ | 1024 QAM | 8.33 |
| 12 | ¾ | 4096 QAM | 9 |
| 13 | ⅚ | 4096 QAM | 10 |
| 14 | UHR DUP | | |
| 15 | 0.5 | BPSK-DCM | 0.25 |

TABLE 6B

| UHR-MCS Index | Code rate | Modulation | Spectral efficiency |
|---|---|---|---|
| 0 | ⅔ | QPSK | 1.33 |
| 1 | ⅚ | QPSK | 1.67 |
| 2 | ⅔ | 16 QAM | 2.67 |
| 3 | ⅚ | 16 QAM | 3.33 |
| 4 | ⅔ | 256 QAM | 5.33 |
| 5 | ⅔ | 4096 QAM | 8 |
| 6 | ⅔ | 16384 QAM | 9.33 |
| 7 | ¾ | 16384 QAM | 10.5 |
| 8 | ⅚ | 16384 QAM | 11.67 |

| | |
|---|---|
| 9-15 | Reserved |

For the UHR-MCS set defined in the optional example 1 of the second embodiment, parameters of the inherited UHR-MCSs are provided in Table 7A and parameters of the non-inherited UHR-MCSs are provided in Table 7B. For the UHR-MCS set defined in the optional example 2 of the first embodiment, UHR-MCS 7 in Table 7B can be removed.

TABLE 7A

| UHR-MCS Index | Code rate | Modulation | Spectral efficiency |
|---|---|---|---|
| 0 | 0.5 | BPSK | 0.5 |
| 1 | 0.5 | QPSK | 1 |
| 2 | ¾ | QPSK | 1.5 |
| 3 | 0.5 | 16 QAM | 2 |
| 4 | ¾ | 16 QAM | 3 |
| 5 | ⅔ | 64 QAM | 4 |
| 6 | ¾ | 64 QAM | 4.5 |
| 7 | ⅚ | 64 QAM | 5 |
| 8 | ¾ | 256 QAM | 6 |
| 9 | Reserved | | |
| 10 | ¾ | 1024 QAM | 7.5 |
| 11 | ⅚ | 1024 QAM | 8.33 |
| 12 | ¾ | 4096 QAM | 9 |
| 13 | ⅚ | 4096 QAM | 10 |
| 14 | UHR DUP | | |
| 15 | 0.5 | BPSK-DCM | 0.25 |

TABLE 7B

| UHR-MCS Index | Code rate | Modulation | Spectral efficiency |
|---|---|---|---|
| 0 | 2/3 | QPSK | 1.33 |
| 1 | ⅚ | QPSK | 1.67 |
| 2 | ⅔ | 16 QAM | 2.67 |
| 3 | ⅚ | 16 QAM | 3.33 |
| 4 | ⅔ | 256 QAM | 5.33 |
| 5 | ⅔ | 1024 QAM | 6.67 |
| 6 | ⅔ | 4096 QAM | 8 |
| 7 | ⅔ | 16384 QAM | 9.33 |
| 8 | ¾ | 16384 QAM | 10.5 |
| 9 | ⅚ | 16384 QAM | 11.67 |

| | |
|---|---|
| 10-15 | Reserved |

In the UHR-SIG field of a UHR MU PPDU, a user field for each intended user of the PSDUs carried in the data field of the UHR MU PPDU includes a 4-bit MCS field and a 1-bit inherited MCS indicator field. The MCS field indicates a UHR-MCS index; and the inherited MCS indicator field indicates whether the UHR-MCS index indicated by the MCS field corresponds to an inherited UHR-MCS. For example, the inherited MCS indicator field is set to 0 to indicate a non-inherited UHR-MCS and set to 1 to indicate an inherited UHR-MCS, or vice versa. In the trigger frame soliciting a UHR TB PPDU from a non-AP STA, a user info field for the non-AP STA includes a 4-bit MCS field and a 1-bit inherited MCS indicator field. The MCS field indicates a UHR-MCS index; and the inherited MCS indicator field indicates whether the UHR-MCS index indicated by the MCS field corresponds to an inherited UHR-MCS. For example, the inherited MCS indicator field is set to 0 to indicate a non-inherited UHR-MCS and set to 1 to indicate an inherited UHR-MCS, or vice versa.

Various embodiments are described. It is understood that the present disclosure is not limited in any way to the embodiments that are represented in the description and the drawings. Many variations and combinations of embodiments are possible within the framework of the present disclosure. Combinations of one or more aspects of the embodiments or combinations of different embodiments are possible within the framework of the present disclosure. All comparable variations are understood to fall within the framework of the present disclosure.

FIG. 2 illustrates an example of a wireless communications system according to an embodiment of the present disclosure. The wireless communications system may be an example of a WLAN 100 (also known as a Wi-Fi network) (such as next generation, eighth generation (GEN8), ultra-high reliability (UHR) Wi-Fi network) configured in accordance with various aspects of the present disclosure. As described herein, the terms next generation, GEN8, and UHR may be considered synonymous and may each correspond to a Wi-Fi network supporting a high volume of space-time-streams. The WLAN 100 may include an AP STA 10 and multiple associated non-AP STAs 20, which may represent devices such as mobile stations, personal digital assistant (PDAs), other handheld devices, netbooks, notebook computers, tablet computers, laptops, display devices (such as TVs, computer monitors, etc.), printers, etc. The AP STA 10 and the associated non-AP STAs 20 may represent a basic service set (BSS) or an extended service set (ESS). The various non-AP STAs 20 in the network can communicate with one another through the AP STA 10. Also illustrated is a coverage area 110 of the AP STA 10, which may represent a basic service area (BSA) of the WLAN 100. An extended network station (not illustrated) associated with the WLAN 100 may be connected to a wired or wireless distribution system that may allow multiple AP STAs 10 to be connected in an ESS.

In some embodiments, a non-AP STA 20 may be located in the intersection of more than one coverage area 110 and may associate with more than one AP STA 10. A single AP STA 10 and an associated set of non-AP STAs 20 may be referred to as a BSS. An ESS is a set of connected BSSs. A distribution system (not illustrated) may be used to connect AP STAs 10 in an ESS. In some cases, the coverage area 110 of an AP STA 10 may be divided into sectors (also not illustrated). The WLAN 100 may include AP STAs 10 of different types (such as a metropolitan area, home network, etc.), with varying and overlapping coverage areas 110. Two non-AP STAs 20 also may communicate directly via a direct wireless link 125 regardless of whether both non-AP STAs 20 are in the same coverage area 110. Examples of direct wireless links 120 may include Wi-Fi direct connections, Wi-Fi tunneled direct link setup (TDLS) links, and other group connections. non-AP STAs 20 and AP STAs 10 may communicate according to the WLAN radio and baseband protocol for physical and media access control (MAC) layers from IEEE 802.11 and versions including, but not limited to, 802.11b, 802.11 g, 802.11a, 802.11n, 802.11ac, 802.11ad, 802.11ah, 802.11ax, 802.11be, 802.11ay, etc. In some other implementations, peer-to-peer connections or ad hoc networks may be implemented within the WLAN 100. Downlink may refer to a communication link from the AP STA to the non-AP STA, and uplink may refer to a communication link from the non-AP STA to the AP STA or the non-AP STA to the non-AP STA.

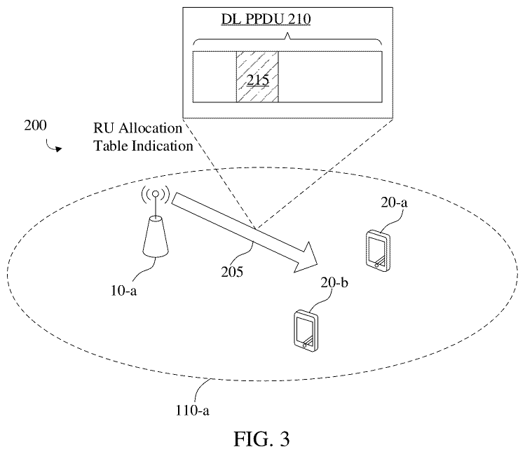

FIG. 3 illustrates an example of a wireless communications system according to another embodiment of the present disclosure. The wireless communications system 200 may be an example of a next generation or UHR Wi-Fi system and may include an AP STA 10-a and non-AP STAs 20-a and 20-b, and a coverage area 110-a, which may be examples of components described with respect to FIG. 3. The AP STA 10-a may transmit a DL PPDU 210 (e.g., UHR MU PPDU) including an RU allocation table indication 215 on the downlink 205 to the non-AP STAs 20.

In some implementations, a wireless communications system 200 may be a next generation Wi-Fi system (such as, a UHR system). In some implementations, wireless communications system 200 may also support multiple communications systems. For instance, wireless communications system 200 may support UHR communications and EHT communications. In some implementations, the non-AP STA 20-a and the non-AP STA 20-b may be different types of non-AP STAs. For example, the non-AP STA 20-a may be an example of a UHR non-AP STA, while the non-AP STA 20-b may be an example of an EHT non-AP STA. The non-AP STA 20-b may be referred to as a legacy non-AP STA. For example, the AP STA 10 may be an example of a UHR AP STA, an example of an EHT AP STA, or a legacy AP STA.

In some instances, UHR communications may support higher modulations than legacy communications. For instance, UHR communications may support 16K quadrature amplitude modulation (QAM), whereas legacy communications may support 4K QAM. UHR communications may support a larger number of spatial streams than legacy systems. In one non-limiting illustrative example, UHR communications may support 16 spatial streams, whereas legacy communications may support 8 spatial streams. In some cases, UHR communications may occur a 2.4 GHz channel, a 5 GHz channel, or a 6 GHz channel in unlicensed spectrum.

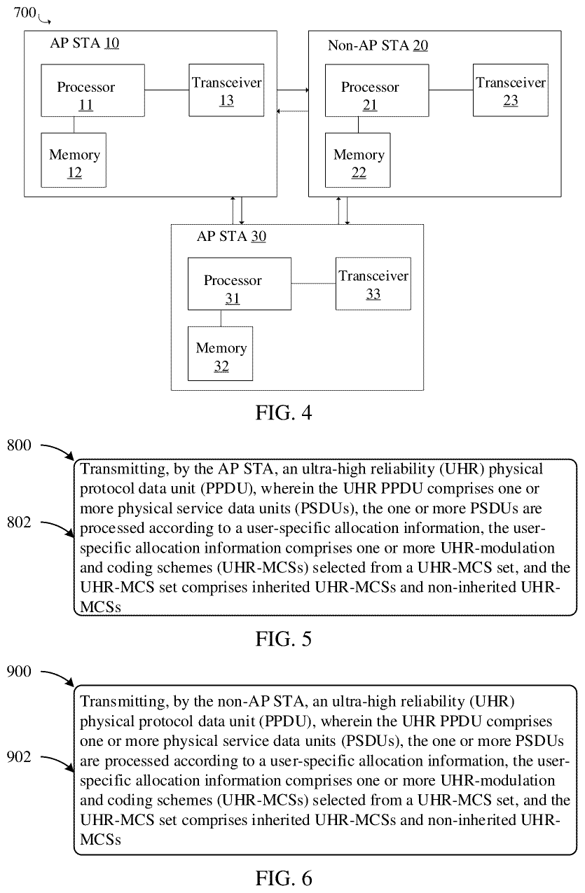

FIG. 4 illustrates one or more non-AP STAs 20, an AP STA 10, and an AP STA 30 of communication in a wireless communications system 700 according to an embodiment of the present disclosure. FIG. 8 illustrates that, the wireless communications system 700 includes an AP STA 10, an AP STA 30 and one or more non-AP STAs 20. The AP STA 10 may include a memory 12, a transceiver 13, and a processor 11 coupled to the memory 12, the transceiver 13. The AP STA 30 may include a memory 32, a transceiver 33, and a processor 31 coupled to the memory 32, the transceiver 33. The one or more non-AP STAs 20 may include a memory 22, a transceiver 23, and a processor 21 coupled to the memory 22, the transceiver 23. The processor 11, 21 or 31 may be configured to implement proposed functions, procedures and/or methods described in this description. Layers of radio interface protocol may be implemented in the processor 11, 21 or 31. The memory 12, 22 or 32 is operatively coupled with the processor 11, 21 or 31 and stores a variety of information to operate the processor 11, 21 or 31. The transceiver 13, 23 or 33 is operatively coupled with the processor 11, 21 or 31, and the transceiver 13, 23 or 33 transmits and/or receives a radio signal.

The processor 11, 21 or 31 may include application-specific integrated circuit (ASIC), other chipset, logic circuit and/or data processing device. The memory 12, 22 or 32 may include read-only memory (ROM), random access memory (RAM), flash memory, memory card, non-transitory storage medium and/or other storage device. The transceiver 13, 23 or 33 may include baseband circuitry to process radio frequency signals. When the embodiments are implemented in software, the techniques described herein can be implemented with modules (e.g., procedures, functions, and so on) that perform the functions described herein. The modules can be stored in the memory 12, 22 or 32 and executed by the processor 11, 21 or 31. The memory 12, 22 or 32 can be implemented within the processor 11, 21 or 31 or external to the processor 11, 21 or 31 in which case those can be communicatively coupled to the processor 11, 21 or 31 via various means as is known in the art.

In some embodiments, the transceiver 13 or 33 is configured to transmit an ultra-high reliability (UHR) physical protocol data unit (PPDU), where the UHR PPDU includes one or more physical service data units (PSDUs), the one or more PSDUs are processed according to a user-specific allocation information, the user-specific allocation information includes one or more UHR-modulation and coding schemes (UHR-MCSs) selected from a UHR-MCS set, and the UHR-MCS set includes inherited UHR-MCSs and/or non-inherited UHR-MCSs. This can solve issues in the prior art, improve system throughput, improve beam forming training, improve beam tracking, improve frequency diversity gain, reduce power consumption, achieve ultra-high throughput, provide good communication performance, and/or provide high reliability.

In some embodiments, the transceiver 23 is configured to transmit an ultra-high reliability (UHR) physical protocol data unit (PPDU), where the UHR PPDU includes one or more physical service data units (PSDUs), the one or more PSDUs are processed according to a user-specific allocation information, the user-specific allocation information includes one or more UHR-modulation and coding schemes (UHR-MCSs) selected from a UHR-MCS set, and the UHR-MCS set includes inherited UHR-MCSs and/or non-inherited UHR-MCSs. This can solve issues in the prior art, improve system throughput, improve beam forming training, improve beam tracking, improve frequency diversity gain, reduce power consumption, achieve ultra-high throughput, provide good communication performance, and/or provide high reliability.

FIG. 5 illustrates a wireless communication method 800 performed by an AP STA according to an embodiment of the present disclosure. In some embodiments, the method 800 includes: a block 802, transmitting, by the AP STA, an ultra-high reliability (UHR) physical protocol data unit (PPDU), where the UHR PPDU includes one or more physical service data units (PSDUs), the one or more PSDUs are processed according to a user-specific allocation information, the user-specific allocation information includes one or more UHR-modulation and coding schemes (UHR-MCSs) selected from a UHR-MCS set, and the UHR-MCS set includes inherited UHR-MCSs and/or non-inherited UHR-MCSs. This can solve issues in the prior art, improve system throughput, improve beam forming training, improve beam tracking, improve frequency diversity gain, reduce power consumption, achieve ultra-high throughput, provide good communication performance, and/or provide high reliability.

Embodiments of the present application provide a wireless communication method. The method includes:
transmitting, by a non-AP STA, an ultra-high reliability (UHR) physical protocol data unit (PPDU), where the UHR PPDU includes one or more physical service data units (PSDUs), the one or more PSDUs are processed according to a user-specific allocation information, the user-specific allocation information includes one or more UHR-modulation and coding schemes (UHR-MCSs) selected from a UHR-MCS set, and the UHR-MCS set includes inherited UHR-MCSs and/or non-inherited UHR-MCSs.

In some embodiments of the present application, a number of the UHR-MCSs in the UHR-MCS set is larger than or equal to a number of extremely high throughput (EHT)-MCSs in an EHT-MCS set.

In some embodiments of the present application, the inherited UHR-MCSs include at least one of a UHR-MCS with binary phase shift keying (BPSK)-dual carrier modulation (DCM), a UHR-MCS with BPSK, a UHR-MCS with quadrature phase shift keying (QPSK) and code rate of ½, a UHR-MCS with QPSK and code rate of ¾, a UHE-MCS with 16 quadrature amplitude modulation (QAM) and code rate of ½, a UHR-MCS with 16 QAM and code rate of ¾, a UHR-MCS with 64 QAM and code rate of ⅔, a UHR-MCS with 64 QAM and code rate of ¾, a UHR-MCS with 64 QAM and code rate of ⅚, a UHR-MCS with 1024 QAM and code rate of ¾, a UHR-MCS with 1024 QAM and code rate of ⅚, a UHR-MCS with 4096 QAM and code rate of ¾, a UHR-MCS with 4096 QAM and code rate of ⅚, a UHR-MCS with 256 QAM and code rate of ¾, or a UHR-MCS with 256 QAM and code rate of ⅚.

In some embodiments of the present application, the non-inherited UHR-MCSs include at least one of a UHR-MCS with QPSK and code rate of ⅔, a UHR-MCS with QPSK and code rate of ⅚, a UHR-MCS with 16 QAM and code rate of ⅔, a UHR-MCS with 16 QAM and code rate of ⅚, a UHR-MCS with 256 QAM and code rate of ⅔, a UHR-MCS with 4096 QAM and code rate of ⅔, a UHR-MCS with 1024 QAM and code rate of ⅔, a UHR-MCS with 16384 QAM and code rate of ⅔, a UHR-MCS with 16384 QAM and code rate of ¾, or a UHR-MCS with 16384 QAM and code rate of ⅚.

In some embodiments of the present application, the UHR PPDU is a UHR multi-user (MU) PPDU or a UHR trigger-based (TB) PPDU.

In some embodiments of the present application, the inherited UHR-MCSs and the non-inherited UHR-MCSs are jointly indexed.

In some embodiments of the present application, the inherited UHR-MCSs are indexed before the non-inherited UHR-MCSs.

In some embodiments of the present application, each of the inherited UHR-MCSs has a same index as an EHT-MCS counterpart of each of the inherited UHR-MCSs.

In some embodiments of the present application, in a UHR-signal (SIG) field of the UHR MU PPDU, a user field for an intended user of the one or more PSDUs indicates a UHR-MCS index for the intended user.

In some embodiments of the present application, the user field for the intended user of the one or more PSDUs includes a 5-bit MCS field, and the 5-bit MCS field indicates the UHR-MCS index for the intended user.

In some embodiments of the present application, the user field for the intended user of the one or more PSDUs includes a 4-bit MCS field and a 1-bit MCS extension field, and the 4-bit MCS field and the 1-bit MCS extension field are combined to indicate the UHR-MCS index for the intended user.

In some embodiments of the present application, in a trigger frame soliciting the UHR TB PPDU, a user information field for the non-AP STA indicates a UHR-MCS index for the non-AP STA.

In some embodiments of the present application, the user information field for the non-AP STA includes a 5-bit MCS field, and the 5-bit MCS field indicates the UHR-MCS index for the non-AP STA.

In some embodiments of the present application, the user information field for the non-AP STA includes a 4-bit MCS field and a 1-bit MCS extension field, and the 4-bit MCS field and the 1-bit MCS extension field are combined to indicate the UHR-MCS index for the non-AP STA.

In some embodiments of the present application, the inherited UHR-MCSs and the non-inherited UHR-MCSs are separately indexed.

In some embodiments of the present application, in a UHR-SIG field of the UHR MU PPDU, a user field for an intended user of the one or more PSDUs includes a 4-bit MCS field which indicates a UHR-MCS index for the intended user and a 1-bit inherited MCS indicator field which indicates whether the UHR-MCS index indicated by the 4-bit MCS field corresponds to one of inherited UHR-MCSs.

In some embodiments of the present application, in a trigger frame soliciting the UHR TB PPDU, a user information field for the non-AP STA includes a 4-bit MCS field which indicates a UHR-MCS index for the non-AP STA and a 1-bit inherited MCS indicator field which indicates whether the UHR-MCS index indicated by the 4-bit MCS field corresponds to one of inherited UHR-MCSs.

In some embodiments of the present application, in 16384 QAM, each constellation point is characterized by an I coordinate and a Q coordinate on an odd-integer grid between-127 and 127 and encodes 14 bits.

In some embodiments of the present application, a final constellation point d is given by: d=(I+jQ)×K_{MOD}, where first 7 bits determine a value of I of the constellation point, subsequent 7 bits determine a value of Q of the constellation point, j is an imaginary part of a complex number, and K_{MOD}=1/sqrt (10922).

In some embodiments of the present application, an encoding of both I and Q follows a gray-coding.

FIG. 6 illustrates a wireless communication method 900 performed by a non-AP STA according to an embodiment of the present disclosure. In some embodiments, the method 900 includes: a block 902, transmitting, by the non-AP STA, an ultra-high reliability (UHR) physical protocol data unit (PPDU), where the UHR PPDU includes one or more physical service data units (PSDUs), the one or more PSDUs are processed according to a user-specific allocation information, the user-specific allocation information includes one or more UHR-modulation and coding schemes (UHR-MCSs) selected from a UHR-MCS set, and the UHR-MCS set includes inherited UHR-MCSs and/or non-inherited UHR-MCSs. This can solve issues in the prior art, improve system throughput, improve beam forming training, improve beam tracking, improve frequency diversity gain, reduce power consumption, achieve ultra-high throughput, provide good communication performance, and/or provide high reliability.

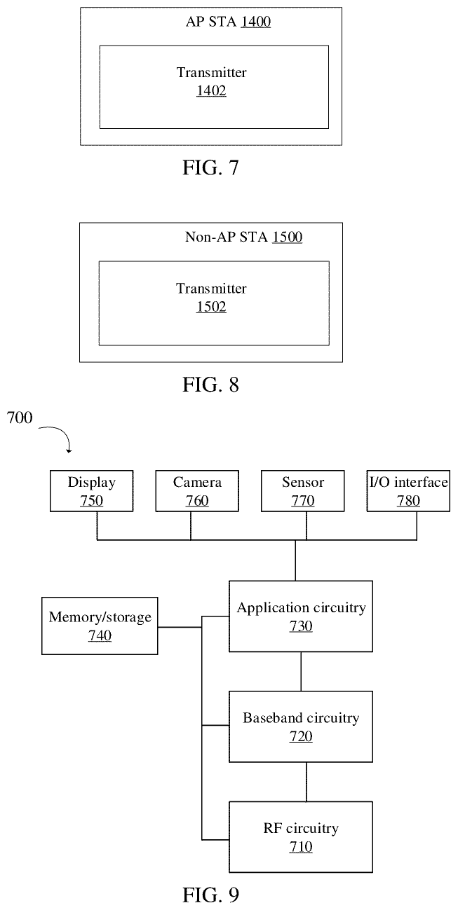

FIG. 7 is a block diagram of an access point (AP) STA 1400 according to an embodiment of the present disclosure. The access point (AP) STA 1400 includes a transmitter 1402 configured to transmit an ultra-high reliability (UHR) physical protocol data unit (PPDU), where the UHR PPDU includes one or more physical service data units (PSDUs), the one or more PSDUs are processed according to a user-specific allocation information, the user-specific allocation information includes one or more UHR-modulation and coding schemes (UHR-MCSs) selected from a UHR-MCS set, and the UHR-MCS set includes inherited UHR-MCSs and/or non-inherited UHR-MCSs. This can solve issues in the prior art, improve system throughput, improve beam forming training, improve beam tracking, improve frequency diversity gain, reduce power consumption, achieve ultra-high throughput, provide good communication performance, and/or provide high reliability. In some embodiments, the UHR capabilities element is included in a probe request frame, an association request frame, or a reassociation request frame.

In some embodiments, a number of the UHR-MCSs in the UHR-MCS set is larger than or equal to a number of extremely high throughput (EHT)-MCSs in an EHT-MCS set. In some embodiments, the inherited UHR-MCSs include at least one of a UHR-MCS with binary phase shift keying (BPSK)-dual carrier modulation (DCM), a UHR-MCS with BPSK, a UHR-MCS with quadrature phase shift keying (QPSK) and code rate of ½, a UHR-MCS with QPSK and code rate of ¾, a UHE-MCS with 16 quadrature amplitude modulation (QAM) and code rate of ½, a UHR-MCS with 16 QAM and code rate of ¾, a UHR-MCS with 64 QAM and code rate of ⅔, a UHR-MCS with 64 QAM and code rate of ¾, a UHR-MCS with 64 QAM and code rate of ⅚, a UHR-MCS with 1024 QAM and code rate of ¾, a UHR-MCS with 1024 QAM and code rate of ⅚, a UHR-MCS with 4096 QAM and code rate of ¾, or a UHR-MCS with 4096 QAM and code rate of ⅚. In some embodiments, the inherited UHR-MCSs include a UHR-MCS with 256 QAM and code rate of ¾ and a UHR-MCS with 256 QAM and code rate of ⅚. In some embodiments, the inherited UHR-MCSs include a UHR-MCS with 256 QAM and code rate of ¾.

In some embodiments, the non-inherited UHR-MCSs include a UHR-MCS with QPSK and code rate of ⅔, a UHR-MCS with QPSK and code rate of ⅚, a UHR-MCS with 16 QAM and code rate of ⅔, a UHR-MCS with 16 QAM and code rate of ⅚, a UHR-MCS with 256 QAM and code rate of ⅔, and a UHR-MCS with 4096 QAM and code rate of ⅔. In some embodiments, the non-inherited UHR-MCSs include a UHR-MCS with 1024 QAM and code rate of ⅔. In some embodiments, the non-inherited UHR-MCSs include a UHR-MCS with 16384 QAM and code rate of ⅔. In some embodiments, the non-inherited UHR-MCSs include a UHR-MCS with 16384 QAM and code rate of ¾, and a UHR-MCS with 16384 QAM and code rate of ⅚. In some embodiments, the UHR PPDU is a UHR multi-user (MU) PPDU or a UHR trigger-based (TB) PPDU.

In some embodiments, the inherited UHR-MCSs and the non-inherited UHR-MCSs are jointly indexed. In some embodiments, the inherited UHR-MCSs are indexed before the non-inherited UHR-MCSs. In some embodiments, each of the inherited UHR-MCSs has a same index as an EHT-MCS counterpart of each of the inherited UHR-MCSs. In some embodiments, in a UHR-signal (SIG) field of the UHR MU PPDU, a user field for an intended user of the one or more PSDUs indicates a UHR-MCS index for the intended user. In some embodiments, the user field for the intended user of the one or more PSDUs includes a 5-bit MCS field, and the 5-bit MCS field indicates the UHR-MCS index for the intended user. In some embodiments, the user field for the intended user of the one or more PSDUs includes a 4-bit MCS field and a 1-bit MCS extension field, and the 4-bit MCS field and the 1-bit MCS extension field are combined to indicate the UHR-MCS index for the intended user.

In some embodiments, in a trigger frame soliciting the UHR TB PPDU, a user information field for the non-AP STA indicates a UHR-MCS index for the non-AP STA. In some embodiments, the user information field for the non-AP STA includes a 5-bit MCS field, and the 5-bit MCS field indicates the UHR-MCS index for the non-AP STA. In some embodiments, the user information field for the non-AP STA includes a 4-bit MCS field and a 1-bit MCS extension field, and the 4-bit MCS field and the 1-bit MCS extension field are combined to indicate the UHR-MCS index for the non-AP STA. In some embodiments, the inherited UHR-MCSs and the non-inherited UHR-MCSs are separately indexed. In some embodiments, in a UHR-SIG field of the UHR MU PPDU, a user field for an intended user of the one or more PSDUs includes a 4-bit MCS field which indicates a UHR-MCS index for the intended user and a 1-bit inherited MCS indicator field which indicates whether the UHR-MCS index indicated by the 4-bit MCS field corresponds to one of inherited UHR-MCSs. In some embodiments, in a trigger frame soliciting the UHR TB PPDU, a user information field for the non-AP STA includes a 4-bit MCS field which indicates a UHR-MCS index for the non-AP STA and a 1-bit inherited MCS indicator field which indicates whether the UHR-MCS index indicated by the 4-bit MCS field corresponds to one of inherited UHR-MCSs.

In some embodiments, in 16384 QAM, each constellation point is characterized by an I coordinate and a Q coordinate on an odd-integer grid between −127 and 127 and encodes 14 bits. In some embodiments, a final constellation point d is given by: d=(I+jQ)× K_{MOD}, where first 7 bits determine a value of I of the constellation point, subsequent 7 bits determine a value of Q of the constellation point, j is an imaginary part of a complex number, and K_{MOD}=1/sqrt (10922). In some embodiments, an encoding of both I and Q follows a gray-coding.

FIG. 8 is a block diagram of a non-AP STA 1500 according to an embodiment of the present disclosure. The non-AP STA 1500 includes a transmitter 1502 configured to transmit, an ultra-high reliability (UHR) physical protocol data unit (PPDU), where the UHR PPDU includes one or more physical service data units (PSDUs), the one or more PSDUs are processed according to a user-specific allocation information, the user-specific allocation information includes one or more UHR-modulation and coding schemes (UHR-MCSs) selected from a UHR-MCS set, and the UHR-MCS set includes inherited UHR-MCSs and/or non-inherited UHR-MCSs. This can solve issues in the prior art, improve system throughput, improve beam forming training, improve beam tracking, improve frequency diversity gain, reduce power consumption, achieve ultra-high throughput, provide good communication performance, and/or provide high reliability.

In some embodiments, a number of the UHR-MCSs in the UHR-MCS set is larger than or equal to a number of extremely high throughput (EHT)-MCSs in an EHT-MCS set. In some embodiments, the inherited UHR-MCSs include at least one of a UHR-MCS with binary phase shift keying (BPSK)-dual carrier modulation (DCM), a UHR-MCS with BPSK, a UHR-MCS with quadrature phase shift keying (QPSK) and code rate of ½, a UHR-MCS with QPSK and code rate of ¾, a UHE-MCS with 16 quadrature amplitude modulation (QAM) and code rate of ½, a UHR-MCS with 16 QAM and code rate of ¾, a UHR-MCS with 64 QAM and code rate of ⅔, a UHR-MCS with 64 QAM and code rate of ¾, a UHR-MCS with 64 QAM and code rate of ⅚, a UHR-MCS with 1024 QAM and code rate of ¾, a UHR-MCS with 1024 QAM and code rate of ⅚, a UHR-MCS with 4096 QAM and code rate of ¾, or a UHR-MCS with 4096 QAM and code rate of ⅚. In some embodiments, the inherited UHR-MCSs include a UHR-MCS with 256 QAM and code rate of ¾ and a UHR-MCS with 256 QAM and code rate of ⅚.

In some embodiments, the inherited UHR-MCSs include a UHR-MCS with 256 QAM and code rate of ¾. In some embodiments, the non-inherited UHR-MCSs include a UHR-MCS with QPSK and code rate of ⅔, a UHR-MCS with QPSK and code rate of ⅚, a UHR-MCS with 16 QAM and code rate of ⅔, a UHR-MCS with 16 QAM and code rate of ⅚, a UHR-MCS with 256 QAM and code rate of ⅔, and a UHR-MCS with 4096 QAM and code rate of ⅔. In some embodiments, the non-inherited UHR-MCSs include a UHR-MCS with 1024 QAM and code rate of ⅔. In some embodiments, the non-inherited UHR-MCSs include a UHR-MCS with 16384 QAM and code rate of ⅔. In some embodiments, the non-inherited UHR-MCSs include a UHR-MCS with 16384 QAM and code rate of ¾, and a UHR-MCS with 16384 QAM and code rate of ⅚.

In some embodiments, the UHR PPDU is a UHR multi-user (MU) PPDU. In some embodiments, the inherited UHR-MCSs and the non-inherited UHR-MCSs are jointly indexed. In some embodiments, the inherited UHR-MCSs are indexed before the non-inherited UHR-MCSs. In some embodiments, each of the inherited UHR-MCSs has a same index as an EHT-MCS counterpart of each of the inherited UHR-MCSs. In some embodiments, in a UHR-signal (SIG) field of the UHR MU PPDU, a user field for an intended user of the one or more PSDUs indicates a UHR-MCS index for the intended user.

In some embodiments, the user field for the intended user of the one or more PSDUs includes a 5-bit MCS field, and the 5-bit MCS field indicates the UHR-MCS index for the intended user. In some embodiments, the user field for the intended user of the one or more PSDUs includes a 4-bit MCS field and a 1-bit MCS extension field, and the 4-bit MCS field and the 1-bit MCS extension field are combined to indicate the UHR-MCS index for the intended user. In some embodiments, the inherited UHR-MCSs and the non-inherited UHR-MCSs are separately indexed. In some embodiments, in a UHR-SIG field of the UHR MU PPDU, a user field for a user which is an intended recipient of the PSDUs includes a 4-bit MCS field which indicates a UHR-MCS index and a 1-bit inherited MCS indicator field which indicates whether the UHR-MCS index indicated by the 4-bit MCS field corresponds to an inherited MCS.

In some embodiments, in 16384 QAM, each constellation point is characterized by an I coordinate and a Q coordinate on an odd-integer grid between −127 and 127 and encodes 14 bits. In some embodiments, a final constellation point d is given by: d=(I+jQ)× K_{MOD}, where first 7 bits determine a value of I of the constellation point, subsequent 7 bits determine a value of Q of the constellation point, j is an imaginary part of a complex number, and K_{MOD}=1/sqrt (10922). In some embodiments, an encoding of both I and Q follows a gray-coding.

Some embodiments of the present disclosure can be adopted in peer to peer (PTP) communication. The phrase “PTP communication”, as used herein, may relate to device-to-device communication over a wireless link (“peer-to-peer link”) between devices. The PTP communication may include, for example, a Wi-Fi direct (WFD) communication, e.g., a WFD P2P communication, wireless communication over a direct link within a quality of service (QOS) basic service set (BSS), a tunneled direct-link setup (TDLS) link, a STA-to-STA communication in an independent basic service set (IBSS), or the like. Some demonstrative embodiments are described herein with respect to Wi-Fi communication. However, other embodiments may be implemented with respect to any other communication schemes, networks, standards, and/or protocols.

Commercial interests for some embodiments are as follows. 1. Solving issues in the prior art. 2. Improving system throughput. 3. Improving beam forming training. 4. Improving beam tracking. 5. Improving frequency diversity gain. 6. Reducing power consumption. 7. Achieving extremely high throughput. 8. Providing a good communication performance. 9. Providing a high reliability. 10. Some embodiments of the present disclosure are used by chipset vendors, communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in communication specification and/or communication standards such as IEEE specification and/or IEEE standards create an end product. Some embodiments of the present disclosure propose technical mechanisms.

FIG. 9 is a block diagram of an example system 700 for wireless communication according to an embodiment of the present disclosure. Embodiments described herein may be implemented into the system using any suitably configured hardware and/or software. FIG. 9 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the AP STA or non-AP STA may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms. The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a non-transitory readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a non-transitory storage medium, including a plurality of commands for a computational device (such as a personal computer, a server, or a network device) to run all or some of the steps disclosed by the embodiments of the present disclosure. The non-transitory storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A wireless communication method by a non-access point (AP) station (STA), comprising:
transmitting, by the non-AP STA, an ultra-high reliability (UHR) physical protocol data unit (PPDU), wherein the UHR PPDU comprises one or more physical service data units (PSDUs), the one or more PSDUs are processed according to a user-specific allocation information, the user-specific allocation information comprises one or more UHR-modulation and coding schemes (UHR-MCSs) selected from a UHR-MCS set, and the UHR-MCS set comprises inherited UHR-MCSs and/or non-inherited UHR-MCSs.

2. The wireless communication method of claim 1, wherein a number of the UHR-MCSs in the UHR-MCS set is larger than or equal to a number of extremely high throughput (EHT)-MCSs in an EHT-MCS set.

3. The wireless communication method of claim 1 wherein the inherited UHR-MCSs comprise at least one of a UHR-MCS with binary phase shift keying (BPSK)-dual carrier modulation (DCM), a UHR-MCS with BPSK, a UHR-MCS with quadrature phase shift keying (QPSK) and code rate of ½, a UHR-MCS with QPSK and code rate of ¾, a UHE-MCS with 16 quadrature amplitude modulation (QAM) and code rate of ½, a UHR-MCS with 16 QAM and code rate of ¾, a UHR-MCS with 64 QAM and code rate of ⅔, a UHR-MCS with 64 QAM and code rate of ¾, a UHR-MCS with 64 QAM and code rate of ⅚, a UHR-MCS with 1024 QAM and code rate of ¾, a UHR-MCS with 1024 QAM and code rate of ⅚, a UHR-MCS with 4096 QAM and code rate of ¾, a UHR-MCS with 4096 QAM and code rate of ⅚, a UHR-MCS with 256 QAM and code rate of ¾, or a UHR-MCS with 256 QAM and code rate of ⅚.

4. The wireless communication method of claim 1, wherein the non-inherited UHR-MCSs comprise at least one of a UHR-MCS with QPSK and code rate of ⅔, a UHR-MCS with QPSK and code rate of ⅚, a UHR-MCS with 16 QAM and code rate of ⅔, a UHR-MCS with 16 QAM and code rate of ⅚, a UHR-MCS with 256 QAM and code rate of ⅔, a UHR-MCS with 4096 QAM and code rate of ⅔, a UHR-MCS with 1024 QAM and code rate of ⅔, a UHR-MCS with 16384 QAM and code rate of ⅔, a UHR-MCS with 16384 QAM and code rate of ¾, or a UHR-MCS with 16384 QAM and code rate of ⅚.

5. The wireless communication method of claim 1, wherein the UHR PPDU is a UHR multi-user (MU) PPDU or a UHR trigger-based (TB) PPDU.

6. The wireless communication method of claim 1, wherein the inherited UHR-MCSs and the non-inherited UHR-MCSs are jointly indexed.

7. The wireless communication method of claim 6, wherein the inherited UHR-MCSs are indexed before the non-inherited UHR-MCSs.

8. The wireless communication method of claim 7, wherein each of the inherited UHR-MCSs has a same index as an EHT-MCS counterpart of each of the inherited UHR-MCSs.

9. The wireless communication method of claim 6, wherein in a UHR-signal (SIG) field of the UHR MU PPDU, a user field for an intended user of the one or more PSDUs indicates a UHR-MCS index for the intended user.

10. The wireless communication method of claim 9, wherein the user field for the intended user of the one or more PSDUs comprises a 5-bit MCS field, and the 5-bit MCS field indicates the UHR-MCS index for the intended user.

11. The wireless communication method of claim 9, wherein the user field for the intended user of the one or more PSDUs comprises a 4-bit MCS field and a 1-bit MCS extension field, and the 4-bit MCS field and the 1-bit MCS extension field are combined to indicate the UHR-MCS index for the intended user.

12. The wireless communication method of claim 6, wherein in a trigger frame soliciting the UHR TB PPDU, a user information field for the non-AP STA indicates a UHR-MCS index for the non-AP STA.

13. The wireless communication method of claim 12, wherein the user information field for the non-AP STA comprises a 5-bit MCS field, and the 5-bit MCS field indicates the UHR-MCS index for the non-AP STA.

14. The wireless communication method of claim 12, wherein the user information field for the non-AP STA comprises a 4-bit MCS field and a 1-bit MCS extension field, and the 4-bit MCS field and the 1-bit MCS extension field are combined to indicate the UHR-MCS index for the non-AP STA.

15. The wireless communication method of claim 1, wherein the inherited UHR-MCSs and the non-inherited UHR-MCSs are separately indexed.

16. The wireless communication method of claim 15, wherein in a UHR-SIG field of the UHR MU PPDU, a user field for an intended user of the one or more PSDUs comprises a 4-bit MCS field which indicates a UHR-MCS index for the intended user and a 1-bit inherited MCS indicator field which indicates whether the UHR-MCS index indicated by the 4-bit MCS field corresponds to one of inherited UHR-MCSs.

17. The wireless communication method of claim 15, wherein in a trigger frame soliciting the UHR TB PPDU, a user information field for the non-AP STA comprises a 4-bit MCS field which indicates a UHR-MCS index for the non-AP STA and a 1-bit inherited MCS indicator field which indicates whether the UHR-MCS index indicated by the 4-bit MCS field corresponds to one of inherited UHR-MCSs.

18. The wireless communication method of claim 1, wherein in 16384 QAM, each constellation point is characterized by an I coordinate and a Q coordinate on an odd-integer grid between-127 and 127 and encodes 14 bits.

19. An access point (AP) station (STA), comprising:
a memory;
a transceiver; and
a processor coupled to the memory and the transceiver;
wherein the AP STA is configured to perform:
transmitting an ultra-high reliability (UHR) physical protocol data unit (PPDU), wherein the UHR PPDU comprises one or more physical service data units (PSDUs), the one or more PSDUs are processed according to a user-specific allocation information, the user-specific allocation information comprises one or more UHR-modulation and coding schemes (UHR-MCSs) selected from a UHR-MCS set, and the UHR-MCS set comprises inherited UHR-MCSs and/or non-inherited UHR-MCSs.

20. A non-access point (AP) station (STA), comprising:
a memory;
a transceiver; and
a processor coupled to the memory and the transceiver;
wherein the non-AP STA is configured to perform:
transmitting an ultra-high reliability (UHR) physical protocol data unit (PPDU), wherein the UHR PPDU comprises one or more physical service data units (PSDUs), the one or more PSDUs are processed according to a user-specific allocation information, the user-specific allocation information comprises one or more UHR-modulation and coding schemes (UHR-MCSs) selected from a UHR-MCS set, and the UHR-MCS set comprises inherited UHR-MCSs and/or non-inherited UHR-MCSs.
